(19) United States
(12) Patent Application Publication
(10) Pub. No.: US 2013/0013343 A1
(43) Pub. Date: Jan. 10, 2013

(54) SYSTEM AND METHOD FOR RISK VALIDATION

(76) Inventors: Amanda B. Christie-Sorensen, Avon, CT (US); Anita L. Kish, Hanover, MD (US)

(21) Appl. No.: 13/179,005

(22) Filed: Jul. 8, 2011

(51) Int. Cl. G06Q 40/00

(52) U.S. Cl. 705/4

(57) ABSTRACT

Systems and methods for validating the level of risk associated with an insurance policy are based on information intrinsic to one or more of the activities covered by the policy, such as a vehicle identification number of a vehicle operated in association with one or more of the activities. From the vehicle identification number, a vehicle type for a vehicle may be determined, and the vehicle type may be used to validate whether the level of risk associated with the policy is appropriate.

### FIELD OF THE INVENTION

The present invention generally relates to systems and methods for validating risks associated with insurance policies. More particularly, the present invention relates to systems and methods for accurately validating the level of risk associated with an insurance policy and/or for identifying misclassified operations covered by a policy, based on available data, information, or characteristics associated with one or more activities that may be covered by the policy.

### BACKGROUND

Historically, insurers have determined the level of risk associated with a policy based on information provided to the insurer by the insured or an insurance agent. For example, when a prospective customer is interested in obtaining quotes for insurance premiums to cover a designated activity, the customer will provide information regarding the type of activity to be covered by the policy to one or more insurers, either directly or through a broker, agent or customer service representative, who may then classify the activity with a program code or other designation, based on the information provided by the customer. The insurers will utilize the information provided by the customer to assess the risk associated with the activity to be covered, and to provide a rating of a policy that covers the activity. Through such a program code or other designation, the information provided by the prospective customer thus serves as a baseline for determining coverage limits under the policy and for calculating premiums, i.e., the dollar amount charged to the customer by the insurer for providing the coverage.

Because the user-supplied information regarding the activity for which coverage is sought acts as a baseline for rating a policy, calculating a premium and determining the level of risk associated with an activity, a misclassification of the activity may cause the policy to be prepared with an inappropriate level of coverage for the activity, or with an insufficient premium to be paid by the prospective customer for the coverage. For example, if the misclassification results in the calculation of a premium that is too high with respect to the actual level of risk associated with the activity, the prospective customer may look elsewhere to obtain coverage for the activity from another insurer. If the estimated premium is too low with respect to the actual level of risk associated with the activity, this may create an unduly large level of exposure for the insurer, and the pool from which claims are to be paid may be underfunded.

An activity may be misclassified by an insurer for a number of reasons. For example, the information provided by a prospective customer or insurance agent, and entered by a customer service representative of the insurer, may contain mistakes such as typographical errors or other unintended inconsistencies. Less innocently, a prospective customer may intentionally misstate or conceal the full extent of the activities for which it seeks coverage, in an attempt to reduce the premium that it must pay to an insurer, or to obtain coverage for which it might otherwise be ineligible.

### SUMMARY OF THE INVENTION

According to some embodiments, the systems and methods of the present invention, are directed to validating the level of risk associated with an insurance policy by maximizing the utilization of available third-party data that has already been provided to an insurer, or is readily available to the insurer. Where an insurance policy includes or covers the use of a vehicle, such third-party data may include, for example, the vehicle identification number, or VIN, of the vehicle included or covered by the policy. The VIN may be provided to the insurer by the customer or by an insurance agent or broker, or by the insurer through one or more third parties or independent means. By permitting an insurer to identify misclassified risk operations during the rating process or prior to issuance, an insurer may vet or otherwise evaluate the vehicles identified in a policy against the designated level of risk associated with the policy.

Therefore, analyzing a VIN with respect to the activity for which coverage is sought may provide an insurer with the advantages of identifying disparities between reported operations and reported vehicles or uses thereof; identifying vehicles that may be outside the insurer's appetite for exposure; maximizing the utilization of data that is already available to the insurer to evaluate levels of risk; applying third-party or user-reported data to obtain a further confirmation of the level of risk; providing a validation of the level of risk at all phases of the preparation of a policy, such as at rating and/or at issuance; and/or making available an additional layer of consideration without any perceptible changes to the customer or the insurer, and without requiring any additional steps to be performed or information to be provided.

For example, where a restaurant owner contacts an insurer to obtain an insurance policy covering his restaurant operations, which include the delivery of food, the restaurant owner indicates that it operates two vehicles in the ordinary course of business. However, when the insurer decodes the VINs of the two vehicles identified by the restaurant owner, the insurer determines that the vehicles are a cement mixer and a limousine, which do not appear to correlate to the restaurant business. According to some embodiments of the present invention, the insurer may divert the restaurant owner's application for insurance to underwriting, which may then analyze the policy and the vehicles in order to determine whether a cement mixer or a limousine are intended to be covered by the restaurant's insurance policy, or whether the premium calculated for the restaurant is appropriate based on the level of risk associated with the operation of a cement mixer and a limousine. The restaurant owner may have provided VINs corresponding to a cement mixer and a limousine for a number of reasons, including an innocent mistake or a fraudulent attempt to include the operations of an unrelated business (e.g., a construction company or livery business) under the coverage of a restaurant policy.

These and other advantages of systems and methods of the present invention will be apparent in view of the drawings, the claims and the following disclosure.

### BRIEF DESCRIPTION OF THE DRAWINGS

Various objects, features, and advantages of the present invention can be more fully appreciated with reference to the following detailed description, when considered in connection with the following drawings.

FIG. 1 is a block diagram of the components of a risk validation system, in accordance with an embodiment of the present invention.

FIG. 2 is a flow chart of a risk validation process according to one embodiment of the present invention.

FIG. 3 is a flow chart of a risk validation process according to one embodiment of the present invention.

FIG. 4 is a flow chart of a process for identifying vehicle types according to one embodiment of the present invention.

FIG. 5 is a flow chart of a process for validating the level of risk associated with an insurance policy according to one embodiment of the present invention.

### DETAILED DESCRIPTION

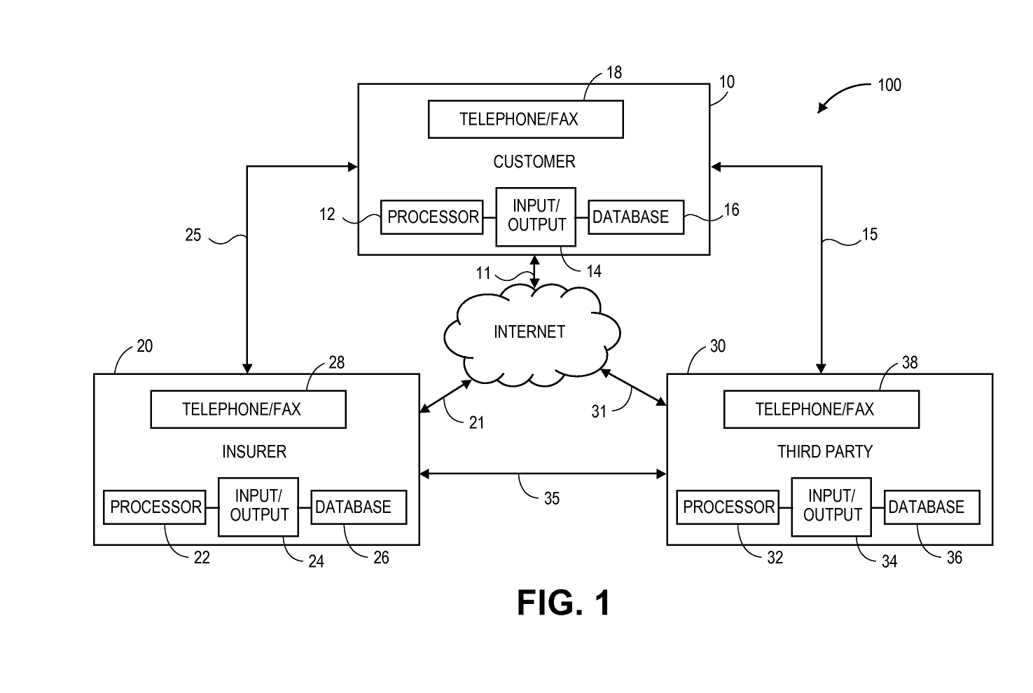

Referring to FIG. 1, a systems-level view of the various components of an electronic (e.g., web-based, network-based, or other electronic or optical, wired or wireless, communication-based) risk validation system 100 according to one embodiment of the present invention is shown. The system 100 includes a customer 10, an insurer 20 and a third party 30.

The system 100 permits a customer 10 and/or its designated representatives to request a policy from an insurer 20, either directly or through a third party 30, and to provide mandatory information regarding the activities to be covered by the policy to the insurer 20. The system 100 further permits the insurer 20 to communicate with the customer 10 and one or more third parties 30, and to calculate a premium or otherwise determine a level of risk associated with the activity in one or more ways. For example, as is shown in FIG. 1, the customer 10 may have or have access to computer systems including one or more processors 12, one or more input/output devices 14 and one or more databases 16 that are connected to a network 40, such as the Internet, via any standard means 11. Similarly, the insured 20 and the third party 30 may have or have access to computer systems including one or more processors 22, 32, one or more input/output devices 24, 34 and one or more databases 26, 36 that are also connected to the network 40 via standard means 21, 31. The customer 10, insured 20 and third party 30 may also have access to a telephone 28, 38, 48 or other similar communications device, such as a facsimile machine. Other arrangements of hardware and software, including various additional networked client and server computers and applications operating thereon, may also be used by the customer 10, the insurer 20 and/or various third parties 30.

Those of skill in the pertinent art will recognize that the one or more customers 10, insurers 20 and third parties 30 may use a keyboard, a keypads, a mouse, a stylus, a touch screen, a “smart” phone or other device (not shown), or a method for using a browser or other like application, to interact with the network 40. The computers, servers, and the like described herein have the necessary electronics, software, memory, storage, databases, firmware, logic/state machines, microprocessors, communication links, displays or other visual or audio user interfaces, printing devices, and any other input/output devices to perform the functions described herein and/or achieve the results described herein.

Except where otherwise explicitly or implicitly indicated herein, the terms “customer,” “insured,” “insurer” or “third party” may also refer to the associated computer systems operated or controlled by a customer, an insured, an insurer, or a third party, respectively. Furthermore, those of skill in the art will also recognize that process steps described herein as being performed by a “customer,” “insured,” “insurer” or “third party” may be automated steps performed by their respective computer systems, and may be implemented within software modules (or computer programs) executed by one or more general purpose computers.

The protocols and components for providing the respective communications between the customer 10, the insurer 20 and third parties 30 over the network 40 or by other means 28, 38, 48 are well known to those skilled in the art of computer communications. As such, they need not be described in more detail herein. Moreover, the data and/or computer executable instructions, programs, firmware, software and the like (also referred to herein as “computer executable components”) described herein may be stored on a computer-readable medium that is within or accessible by computers or servers and may have sequences of instructions which, when executed by a processor (such as a central processing unit, or CPU), may cause the processor to perform all or a portion of the functions and/or methods described herein. Such computer executable instructions, programs, software and the like may be loaded into the memories of computers or servers, using drive mechanisms associated with a computer readable medium, such as a floppy drive, CD-ROM drive, DVD-ROM drive, network interface, or the like, or via external connections.

A Vehicle Identification Number, or VIN, is a unique identifying number that is assigned to a motor vehicle at the time of assembly. Although the use of VINs dates to the 1950s, when the mass production of automobiles for personal use greatly increased, there was no set standard or format for VINs, and no requirement that any specific information be included in a VIN for nearly three decades. In 1981, the United States National Highway Traffic Safety Administration required that all VINs that are applied to automobiles sold in the United States must include seventeen alphanumeric characters, without spaces, and each of the alphanumeric characters must have a designated meaning or serve a specific purpose. Each of the characters in a VIN must be one of 33 alphanumeric characters, including numbers ranging from 0 to 9, and letters ranging from A to Z, excluding the letters I, O and Q, in order to avoid confusion with the numbers 1 and 0.

In the United States, the standard for the format and information to be provided in a VIN is codified in 49 C.F.R. §565. According to these regulations, a VIN is to consist of four sections of characters, including a World Manufacturer's Identification (WMI) section, a Vehicle Description Section (VDS), a check digit and a section consisting of a serial number.

The first three characters of a vehicle's VIN are the WMI, a three-character code that identifies the manufacturer of the vehicle according to a standard developed by the Society of Automotive Engineers. The first character of the WMI identifies the region of the world where the vehicle originated. For example, where the first character of a WMI is a number from 1 to 5, the vehicle originated in North America. Where the first character of a WMI is a letter from J to R, the vehicle originated in Asia, while a first character from S to Z indicates that the vehicle originated in Europe.

In conjunction with the first character, the second character of the WMI refers to the country where the vehicle was finally assembled. For example, a vehicle with a WMI beginning with characters ranging from 1A to 10 originated in the United States, while a vehicle with a WMI beginning with characters ranging from 3A to 3W originated in Mexico. Within the region identified by the first character of the WMI, the second character of the WMI is typically used to designate a particular manufacturer that produces vehicles in a country. For example, a WMI beginning with the characters 1G corresponds to vehicles assembled by General Motors Corporation in the United States, while a WMI beginning with the characters JH corresponds to vehicles assembled by Honda Motor Company, Ltd., in Japan.

The third character of the WMI is used to broadly refer to the kind of vehicle produced by a manufacturer. If the manufacturer produces 500 or more vehicles per year, the third character of the WMI identifies the kind of vehicle. For example, a WMI of 1G3 refers to a Chevrolet truck manufactured in the United States by General Motors, while a WMI of JH4 corresponds to a gasoline-powered Honda passenger car that is manufactured in Japan. However, if the vehicle was assembled by a manufacturer that produces fewer than 500 vehicles per year, the third character of the WMI is limited to the number “9,” which indicates that the vehicle manufacturer may be identified by resort to the first through third characters and the tenth through twelfth characters.

The next five characters of the VIN, i.e., the fourth through the eighth characters, represent the VDS of the VIN. These five characters describe the vehicle, and can provide information such as the vehicle's make, line, series, body type, engine type, available restraint devices and gross vehicle weight. For example, on most vehicles sold in the United States, the fourth character corresponds to the restraint system (e.g., brakes) provided in the car, while the fifth, sixth and seventh characters correspond to the line (e.g., Chevrolet Cavalier or Volkswagen Jetta), series (e.g., Type-10 Cavalier or Jetta GLS) and type (e.g., passenger car) of the vehicle, and the eighth character corresponds to the engine type of the vehicle (e.g., 2.0 liter four-cylinder).

The ninth character of the VIN is a check digit for verifying the accuracy of the VIN. The check digit is mathematically calculated based on the values of the other 16 characters in the VIN (i.e., the first through eighth and tenth through seventeenth characters), as follows. First, where a character of the VIN is a letter, the letter is transliterated by assigning a numerical value to the character represented by letters in the VIN, as is set forth below in Table 1.

TABLE 1
Numerical Values Assigned to Characters in VINs for Calculating Check Digit

| Character | A | B | C | D | E | F | G | H | J | K | L | M | N | P | R | S | T | U | V | W | X | Y | Z |
|---|---|---|---|---|---|---|---|---|---|---|---|---|---|---|---|---|---|---|---|---|---|---|---|
| Numerical | 1 | 2 | 3 | 4 | 5 | 6 | 7 | 8 | 1 | 2 | 3 | 4 | 5 | 7 | 9 | 2 | 3 | 4 | 5 | 6 | 7 | 8 | 9 |
| Value | | | | | | | | | | | | | | | | | | | | | | | |

Where a character of the VIN is a number, that number is assigned as the numerical value for the character.

Next, a weight, or a multiplier, is applied to each of the characters in the VIN, including both letters and numbers, as is set forth below in Table 2.

TABLE 2
Weights Assigned to Characters in VINs for Calculating Check Digit

| Character | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|
| Weight | 8 | 7 | 6 | 5 | 4 | 3 | 2 | 10 | 0 | 9 | 8 | 7 | 6 | 5 | 4 | 3 | 2 |

Finally, the check digit is calculated by multiplying each of the numerical values associated with a character by its respective multiplier, adding the products together, and dividing the sum of the products by 11, according to equation (1), below.

$$\frac{{\sum }_{i = 1}^{1 - 8 , 10 - 17} ( {numerical}_{i} \cdot {multiplier}_{i} )}{11} \qquad ( 1 )$$

where numerical, is the numerical value corresponding to character i of the VIN, as shown in Table 1, above; where multiplierᵢ is the multiplier corresponding to character i of the VIN, as shown in Table 2, above; and where characters i are the first through eighth and tenth through seventeenth characters of the VIN.

The remainder of the quotient determined by equation (1), above, represents the check digit to be included the ninth character of the VIN, and may be rounded, if necessary. For example, where a Nissan Sentra has a VIN of 3N1AB61E49L646222, the sum of the products of the respective numerical values and multipliers is 367. Dividing the sum of 367 by 11, according to equation (1), above, results in a quotient of 33 4/11. Therefore, the check digit in the ninth character of the VIN is 4.

The tenth character of the VIN represents the model year of the vehicle. The values associated with the model years include the characters B, C, D, E, F, G, H, J, K, L, M, N, P, R, S, T, V, W, X, Y, 1, 2, 3, 4, 5, 6, 7, 8, 9 and A, and are repeated every thirty years, beginning in 1981. For example, the value B was used to refer to the year 1981, while the value 1 refers to the year 2001 and the value A refers to the year 2010. In 2011, the sequence was repeated, and the value B also refers to the year 2011. The model years and values are set forth in Table 3, below.

TABLE 3
Model Years and Values in the Tenth
Characters of VINs, 1981-2040

| Year | Value |
|---|---|
| 1981 | B |
| 1982 | C |
| 1983 | D |
| 1984 | E |
| 1985 | F |
| 1986 | G |
| 1987 | H |
| 1988 | J |
| 1989 | K |
| 1990 | L |
| 1991 | M |
| 1992 | N |
| 1993 | P |
| 1994 | R |
| 1995 | S |
| 1996 | T |
| 1997 | V |
| 1998 | W |
| 1999 | X |
| 2000 | Y |
| 2001 | 1 |
| 2002 | 2 |
| 2003 | 3 |
| 2004 | 4 |
| 2005 | 5 |
| 2006 | 6 |
| 2007 | 7 |
| 2008 | 8 |
| 2009 | 9 |
| 2010 | A |
| 2011 | B |
| 2012 | C |
| 2013 | D |
| 2014 | E |
| 2015 | F |
| 2016 | G |
| 2017 | H |
| 2018 | J |
| 2019 | K |
| 2020 | L |
| 2021 | M |
| 2022 | N |
| 2023 | P |
| 2024 | R |
| 2025 | S |
| 2026 | T |
| 2027 | V |
| 2028 | W |
| 2029 | X |
| 2030 | Y |
| 2031 | 1 |
| 2032 | 2 |
| 2033 | 3 |
| 2034 | 4 |
| 2035 | 5 |
| 2036 | 6 |
| 2037 | 7 |
| 2038 | 8 |
| 2039 | 9 |
| 2040 | A |

The eleventh character of the VIN typically corresponds to the particular plant where the vehicle was finally assembled, and is thus specific to the particular vehicle manufacturer.

When the vehicle is produced by a manufacturer of more than 500 vehicles per year, i.e., where the third character of the VIN is something other than a 9, the twelfth through seventeenth characters of the VIN combine to form a unique production sequence number, or serial number, that corresponds to the specific vehicle. While the first eight and the tenth characters of a VIN may be common to the VINs of other vehicles having the same country of origin, manufacturer, body type, car line, restraint system, engine, braking system, year of manufacture, and final assembly point, the final six characters of the VIN are unique to each individual vehicle. For example, every 1995 Chevrolet S-10 Blazer sport-utility vehicle having a standard brake system, a gross vehicle weight rating of less than 6,000 pounds, and a 4.3-liter V6 gasoline engine that was assembled in Moraine, Ohio, will have a VIN beginning with the first through eighth characters of 1GNDT13W, a tenth character of S and an eleventh character of 2. The twelfth through seventeenth characters, as well as the check digit in the ninth character, will be different for each specific vehicle.

Additionally, where the vehicle is assembled by a manufacturer who produces fewer than 500 automobiles per year, i.e., where the third character of the WMI is a “9,” the twelfth through fourteenth characters also further identify the type of the vehicle, and the fifteenth through seventeenth characters represent the serial number of the vehicle.

Accordingly, decoding a VIN can provide a substantial amount of information about a vehicle. For example, where a vehicle has a VIN of 1HGCP36869A038980, one is aware that the vehicle's WMI is 1HG, which indicates that the vehicle is a passenger vehicle produced in the United States by Honda of America Manufacturing, Inc. (based on the first three characters, or 1HG). The vehicle has standard brakes (based on the fourth character, or C) and a 3.5 liter V-6 gasoline engine (based on the eighth character, or 8), and is an Accord EX-L passenger car (based on the fifth, sixth and seventh characters, or P36). From the VIN, one can also discern that the vehicle was produced in the model year of 2009 (based on the tenth character, or 9), and was assembled at a plant in Marysville, Ohio (based on the eleventh character, or A). The vehicle's serial number is represented by the final six characters, or 038980.

Similarly, where a vehicle has a VIN of 2FMDK4KC6BBA73994, one is aware that the vehicle's WMI is 2FM, which indicates that the vehicle is a sport-utility vehicle produced by the Ford Motor Company in Canada (based on the first three characters, or 2FM). One can also tell that the vehicle has standard brakes (based on the fourth character, or D) and a 3.5 liter V-6 gasoline engine (based on the eighth character, or C), and is an Edge Limited series sport-utility vehicle (based on the fifth, sixth and seventh characters, or K4K). From the VIN, one can also discern that the vehicle was produced in the model year 2011 (based on the tenth character, or B) and was assembled at a plant in Oakville, Ontario (based on the eleventh character, or B). The vehicle's serial number is represented by the final six characters, or A73994.

Because a VIN provides a unique, coded set of information that is intrinsic to an individual vehicle, and is applied to the vehicle by its manufacturer, comparing the information represented by the VIN to the information regarding the activity for which coverage is sought by the customer, provides one measure for validating the level of risk associated with the policy.

Validating the level of risk associated with an insurance policy using one or more intrinsic identifiers, such as a VIN, may be performed at any point in time when a policy's coverage levels are under consideration. Preferably, a VIN may be used to validate the level of risk during “rating,” i.e., when the extent of coverage and level of premium are determined by the insurer using a rating system and offered to a prospective customer, or at “issuance,” i.e., when the prospective customer has agreed to the terms and conditions of the policy, and when coverage under the policy is about to begin.

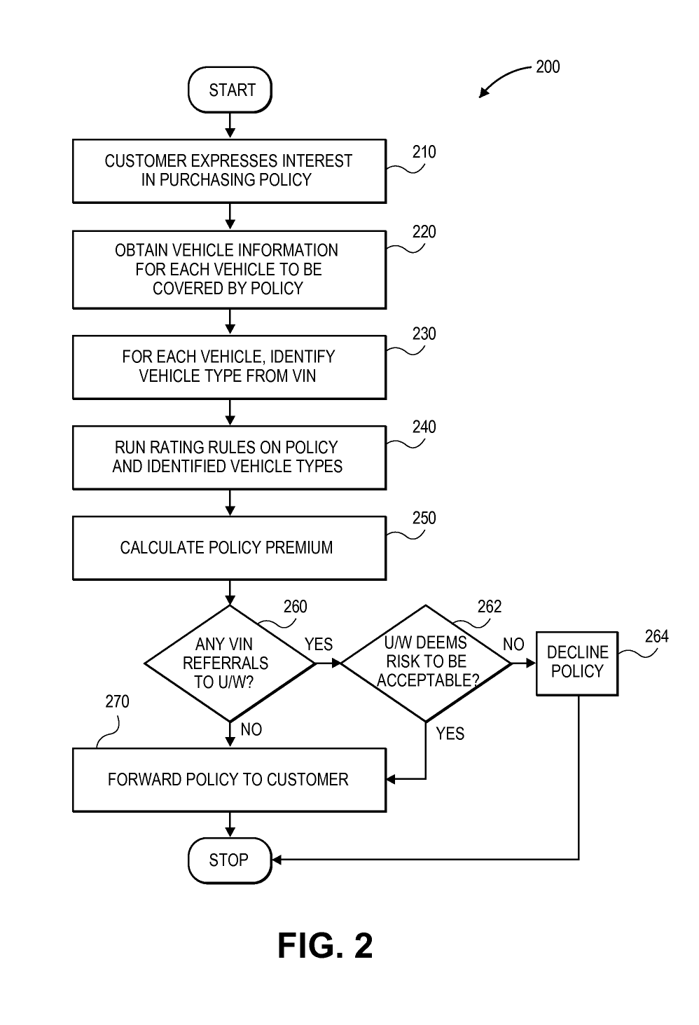

Referring to FIG. 2, a flow chart 200 describing a process for validating the level of risk associated with a policy based on the VINs of the vehicles covered by that policy at the time of rating is shown. The process begins at block 210, where a prospective customer expresses interest in purchasing a policy. At block 220, the insurer obtains information regarding the activity for which coverage is sought, including a listing of the vehicles to be covered under the policy and their respective VINs. At block 230, for each of the vehicles identified by the prospective customer, a vehicle type for each of the vehicles is identified from the VIN. For example, the vehicle type may be derived from the WMI, i.e., the first three characters of the VIN which may identify the region and country where the vehicle was assembled, the manufacturer of the vehicle, and a broad description of the kind of vehicle. Additionally, the vehicle type may also be derived from the VDS, i.e., the fourth through eighth characters of the VIN that identify the vehicle's make, line, series, body type, engine type, available restraint devices and/or gross vehicle weight. At block 240, the insurer runs one or more business rules, such as rating underwriting rules, against the vehicles identified in the policy. For example, the system may compare the information provided by the customer regarding the activity for which coverage is sought to the vehicle types determined from the VINs. At block 250, the policy premium is calculated based on the rating underwriting rules.

At block 260, it is determined whether any of the vehicles must be referred to underwriting for further analysis, based on the business rules, the premium, and the types of vehicles identified, or on any inconsistency identified by the system. If any of the vehicles must be referred, then at block 262, underwriting reviews the policy to determine whether the risk associated with the policy is deemed to be acceptable. If underwriting determines that the risk associated with the policy is unacceptable, then the policy is declined at block 264. If none of the vehicles must be referred to underwriting, or if underwriting determines the risk associated with the policy to be acceptable, then the policy is forwarded to the customer for its review at block 270.

A vehicle may be referred to underwriting for a variety of reasons. For example, an inconsistency between the vehicle type identified through the VIN and the activity for which the customer requests a policy may prompt underwriting to analyze the request for a policy to determine whether the activity is inconsistent with or otherwise beyond the scope of its appetite in that regard. Alternatively, the basis for denying a policy may be automatic or strict: if the insurer does not insure race cars as a matter of practice, then where a vehicle is determined to be a race car based on its VIN, the request for a policy may be denied automatically, without ever referring the vehicle to underwriting. Furthermore, instead of denying a policy outright based on a risk determination, the systems and methods of the present invention may recommend that the policy be assigned or referred to another business unit or other aspect of the insurer's operations for which the policy may be more appropriately suited. Where a construction company requests that an insurer provide an insurance policy covering truck operations, for example, the level of risk associated with the policy may exceed the applicable limits for a standard automobile policy, but may be within the risk appetite associated with a specialized policy group associated with the insurer, such as a business insurance group or a construction insurance group. The systems and methods of the present invention may therefore reassign or redirect the policy to the more appropriate group within the insurer.

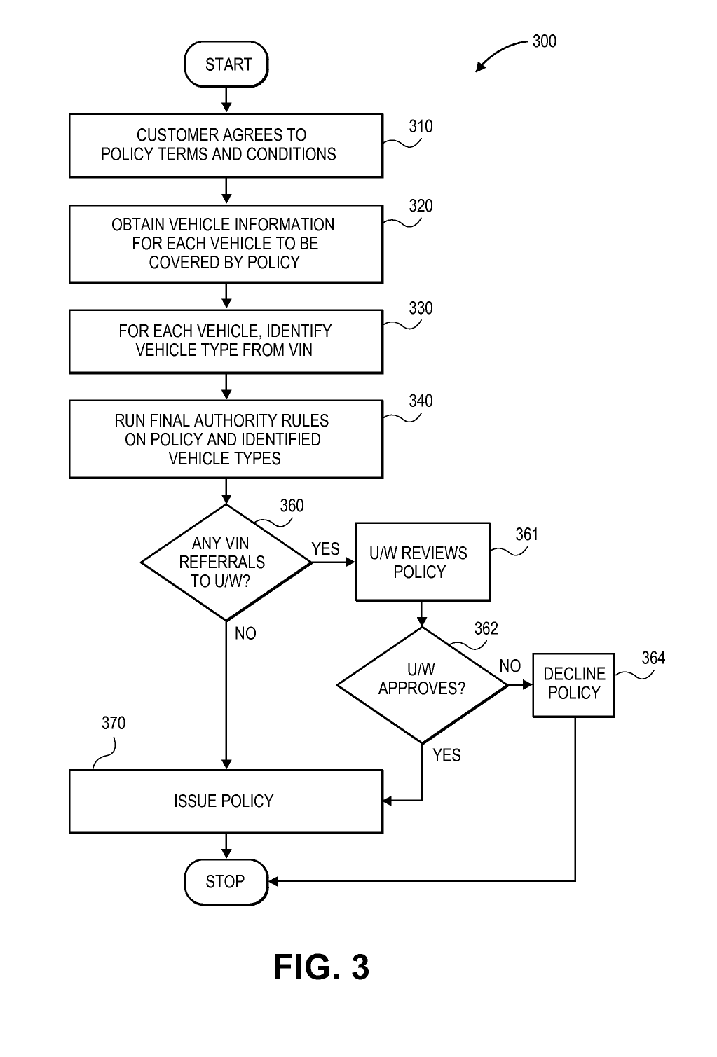

In addition to validating a level of risk at the time of rating, VINs may also be used to validate the level of risk associated with a policy at issuance, i.e., after the customer has agreed to the terms and conditions of the policy, including the limits of coverage and the premium. Referring to FIG. 3, a flow chart 300 describing a process for validating the level of risk associated with a policy at issuance is shown. Except where otherwise noted, reference numerals preceded by the number “3” in FIG. 3 indicate elements that are similar to elements of the flow chart 200 shown in FIG. 2 as having reference numerals preceded by the number “2.”

The process represented by flow chart 300 begins at block 310, where the customer agrees to the terms and conditions associated with the policy. At block 320, the insurer obtains a listing of the vehicles to be covered under the policy and their respective VINs. At block 330, the system again determines, for each of the vehicles listed in the policy, the vehicle types based on each of the VINs, e.g., by analyzing or decoding the information stored in the WMI or VDS sections of the VIN. At block 340, the policy may be subject to one or more business rules, such as final authority rules, which may compare the activity for which coverage is sought to the vehicle types identified using each of the VINs. At block 360, it is determined whether any of the vehicles must be referred to underwriting, based on the vehicle types identified. If so, at block 361, the policy is sent to underwriting for further analysis prior to issuing the policy. If the policy need not be forwarded to underwriting for review, or if underwriting approves the risk associated with the policy, then the policy is issued at block 370. If underwriting declines the policy at block 364, the policy is not issued (i.e., declined).

The processes described in flow chart 200 of FIG. 2, and in flow chart 300 of FIG. 3, provide broad overviews of individual methods for validating risk based on a comparison of an intrinsic identifier, such as a VIN, to one or more activities for which coverage is sought. However, because a VIN provides a variety of comprehensive information regarding a vehicle, a number of other, more detailed analyses of policies may be performed.

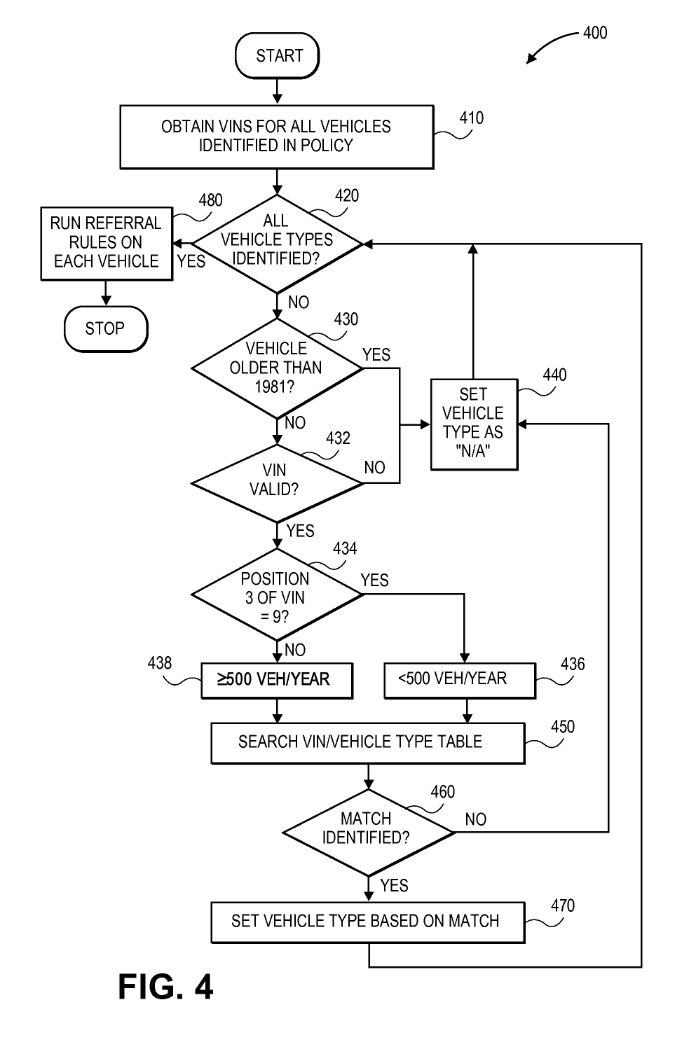

Referring to FIG. 4, a flow chart 400 representing one embodiment of a process performed by a system to determine a vehicle type based on information provided by a prospective customer, such as a VIN, is shown. The process begins at block 410, where the system obtains VINs for each of the vehicles identified in a policy. Next, at block 420, the system determines whether vehicle types have been determined for each of the vehicles identified in the policy. If vehicle types have been determined for each of the vehicles identified in the policy, then at block 480, the system runs one or more business rules, such as referral rules, on each of the vehicles. If vehicle types have not been determined for each of the vehicles, then at block 430, the system begins a loop for each of the vehicles for which types have not yet been determined.

At block 430, it is determined whether an individual vehicle has a model year that is older than 1981, based on the tenth character of the VIN. As is discussed above, the United States National Highway Traffic Safety Administration first required that all VINs include seventeen alphanumeric characters in 1981. If the vehicle model year is older than 1981, then standard analytical principles applicable to VINs of vehicles from the model year 1981 or later will not apply. Therefore, if the vehicle model year is older than 1981, the system sets the vehicle type as “N/A” at block 440, and returns to block 420.

If the vehicle model year is 1981 or later, based on the tenth character of the VIN, then the validity of the VIN is determined at block 432. The validity of a VIN may be determined in a number of ways. For example, as is discussed above, the ninth character of a VIN corresponds to a check digit based on the values provided in the first through eighth and tenth through seventeenth characters. Therefore, the check digit may be validated by independently calculating a checksum according to equation (1), above, based on the values provided in the first through eighth and the tenth through seventeenth characters of the VIN; and comparing the independently calculated checksum to the ninth character of the VIN. If the independently calculated checksum matches the ninth character of the VIN, the VIN is presumed to be valid.

Additionally, any number of additional logic tests may be applied to the information provided in the VIN, in order to confirm that the VIN is valid. For example, if the WMI in a VIN associated with a BMW X3 model sport-utility vehicle is 4US, indicating that the vehicle was assembled at a BMW plant in the United States, and the tenth character of the VIN is a 4, indicating that the model year is 2004, the VIN may be presumed to be invalid because the BMW X3 model sport-utility vehicle was first assembled in the United States in 2010. Likewise, any other logic test or check which compares the information provided in a VIN to externally available and verifiable information may be used to determine whether a VIN is valid. If a VIN is determined to be invalid for any reason, then, at block 440, the vehicle type is set as “N/A,” and the process returns to block 420.

At block 434, it is determined whether the third character of the WMI of the VIN is a “9,” to identify whether the vehicle's manufacturer produces fewer than 500 vehicles per year, or 500 or more vehicles per year. As is discussed above, determining whether the manufacturer produces 500 or more vehicles per year, or fewer than 500 vehicles per year, determines where, within a VIN, the vehicle type information is stored. Where the third character is something other than a “9,” it is understood that the manufacturer produces 500 or more vehicles per year, and the system acknowledges, at block 438, that information regarding the vehicle type is stored in the first through eighth characters and the tenth character of the VIN. Where the third character is a “9,” the manufacturer produces fewer than 500 vehicles per year, and the system acknowledges, at block 436, that information regarding the vehicle type is stored in the first through eighth, tenth and twelfth through fourteenth characters of the VIN.

Once the system defines where, within the VIN, vehicle type information is located, the system then searches a database or bank of information, at block 450, in order to identify a vehicle type corresponding to the characters of the VIN identified in block 436 or block 438. At block 460, if the system is able to identify a match between the characters of the VIN identified in block 436 or block 438 and a vehicle type in the database, then at block 470, the vehicle type is determined based on the match, and the process returns to block 420. If no match is identified, then the vehicle type is set as “N/A,” at block 440, and the process returns to block 420.

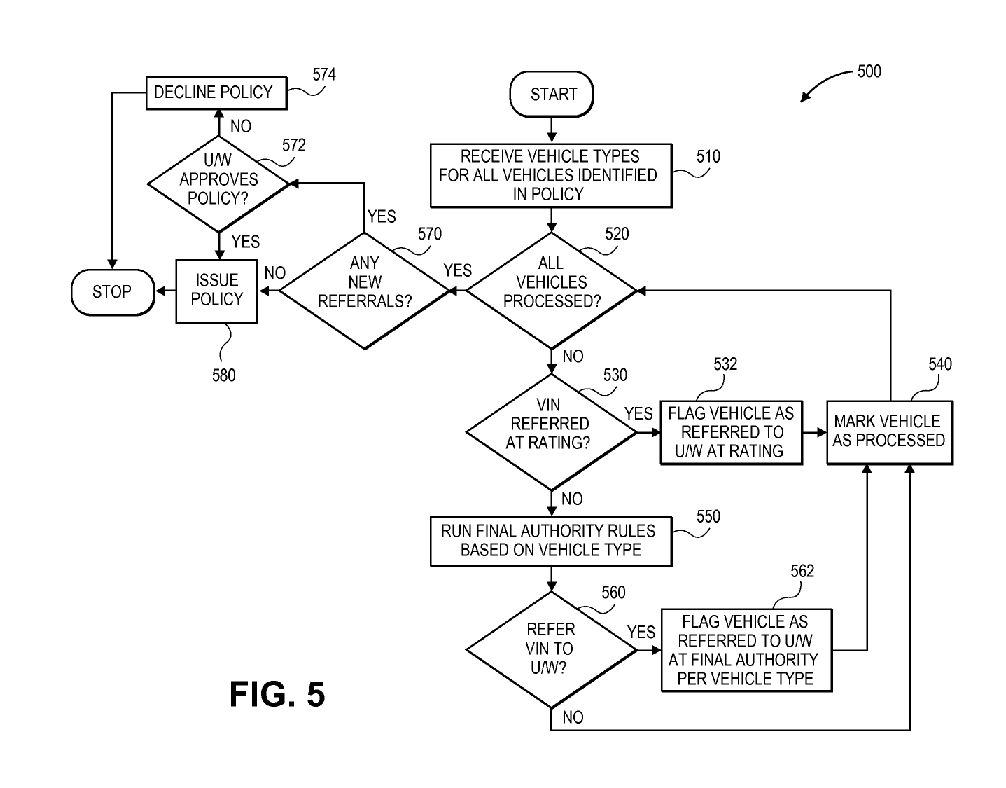

After a vehicle type has been identified for each vehicle listed in the policy based on the VIN, or has not been identified and has been designated as “N/A,” the vehicle types may be analyzed in accordance with one or more referral rules. As is discussed above, the analysis of a policy with respect to vehicle types identified based on VINs may be performed at the time of rating and/or at the time of issuance. Referring to FIG. 5, a flow chart 500 representing a process for validating the risk associated with a policy at the time of issuance is shown. The process represented in flow chart 500 begins at block 510, where the process receives vehicle types for each of the vehicles listed in the policy.

At block 520, the system determines whether each of the vehicles listed in the policy has been processed according to the referral rules. If all of the vehicles have not been processed, then, beginning at block 530, for each of the vehicles identified in the policy, the system determines whether the vehicle was referred to underwriting or otherwise identified as having a vehicle type of “N/A” during the rating process. If the vehicle was referred to underwriting or was otherwise identified as having a vehicle type of “N/A,” then at block 532, the vehicle is flagged as having been referred during the rating process, and at block 540, the vehicle is marked as processed before the process returns to block 520.

If a vehicle was not referred to underwriting during the rating process, then one or more business rules, such as final authority rules, may be run on the information provided regarding the vehicle, including the vehicle type, at block 550. For example, one final authority rule that may be run on the information provided is a “high end” rule, which may compare the vehicle type obtained from a VIN to determine whether the particular vehicle qualifies as “high end,” based on its purchase price, operational characteristics, maintenance costs or other factors.

Based on the results of the final authority rules, at block 560, it is determined whether the vehicle is to be referred to underwriting. If so, the vehicle is flagged as referred at the final authority stage, based on the vehicle type, and the vehicle is marked as processed at block 540. If not, the vehicle is marked as processed at block 540, and the process returns to block 520.

When all of the vehicles have been processed, then at block 570, the system determines whether any of the vehicles in the policy have been flagged as referred to underwriting for further analysis, either during the rating process or following one or more final authority rules, such as at block 532 and block 562. If none of the vehicles has been referred to underwriting, then the policy is deemed to carry a level of risk commensurate with the vehicle types identified by decoding the VIN, and the policy issues to the prospective customer at block 580. If one or more of the vehicles has been referred to underwriting, then at block 572, the policy is sent to underwriting for further review prior to issuance. Underwriting may then decline the policy at block 574 or issue the policy at block 580, depending on the results of its analysis.

The systems and methods of the present invention may be utilized to validate the level of risk associated with an activity at any time. For example, in addition to validating risk at rating and at issuance, the present invention may be utilized to validate the level of risk at the time of renewal.

Additionally, any number of business rules may be applied to rate a policy, price a premium for a policy, determine the customer's eligibility for the policy or otherwise validate the level of risk based on the information provided in a VIN. For example, with regard to applications for which the type of engine (e.g., gasoline, diesel, hybrid) may be relevant to the level of risk, the type of engine identified by the customer may be validated against the eighth character of the VIN. When a particular model year of a vehicle, or a vehicle assembled in a particular plant, has been identified as being structurally deficient and/or prone to manufacturer recalls, the model year of the vehicle or the location of its final assembly identified by the customer may be validated against the tenth or eleventh characters of the VIN.

Moreover, the systems and methods of the present invention are not limited to risk validation based on automobiles and/or using VINs. For example, various pieces of construction equipment are typically identified using a serial or other identification number that inherently carries information regarding the type of equipment. Such a number could be used to determine the type of equipment, and therefore validate the level of risk associated with the equipment. Similarly, where a business owner requests a quote for property insurance and indicates that a particular parcel is zoned for a particular use (e.g., commercial use), classifiers listed in local property or tax records may be consulted to determine whether the parcel is zoned for the particular use identified by the business owner, or for another use (e.g., industrial use or residential use), in accordance with the present invention.

It is to be understood that the embodiments described above are not limited in application to the details of construction and to the arrangements of the components set forth in the above description or illustrated in the drawings. The present invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the scope of the present invention, as defined by the claims.

In addition, features illustrated or described as part of one embodiment can be used in other embodiments to yield a still further embodiment. Additionally, certain features may be interchanged with similar devices or features not mentioned that perform the same or similar functions. It is therefore intended that such modifications and variations are included within the totality of the present invention.

The many features and advantages of the invention are apparent from the detailed specification, and thus, the appended claims are intended to cover all such features and advantages that fall within the scope of the invention. Further, since numerous modifications and variations will readily occur to those skilled in the art, it is not desired to limit the invention to the exact constructions and operations illustrated and described herein. Accordingly, all suitable modifications and equivalents may be deemed to fall within the scope of the invention.

For example, the specific sequence of the processes described above may be altered so that certain processes are conducted in parallel or independent with other processes, to the extent that the processes are not dependent upon each other. Thus, the specific order of steps described herein, are not to be considered implying a specific sequence of steps to perform the processes described above. Other alterations or modifications of the above processes are also contemplated, and further insubstantial approximations of the above equations, processes and/or algorithms are also considered within the scope of the processes described herein.

What is claimed is:

1. A computer-based system for risk validation, comprising:
a server; and
at least one computer having at least one processor and at least one database,
wherein the at least one database is in communication with the at least one processor and has specially-programmed instructions stored thereon that, when executed by the processor, perform the method comprising:
receiving, by the server, a request for an insurance policy covering at least one activity, wherein the at least one activity includes an operation of at least one vehicle;
determining a classification of a risk associated with the at least one activity;
generating the insurance policy based on the classification;
obtaining an identification number for the at least one vehicle;
determining a vehicle type of the at least one vehicle based on the identification number; and
validating the risk based on the vehicle type.

2. The system according to claim 1, wherein the method further comprises:
calculating a premium for the insurance policy based on the risk.

3. The system according to claim 1, wherein the method further comprises:
if the risk is validated based on the vehicle type, issuing the insurance policy; and
if the risk is not validated based on the vehicle type, sending the insurance policy to an underwriter.

4. The system according to claim 1, wherein determining the vehicle type comprises:
comparing the identification number of the at least one vehicle to at least one stored identification number in the at least one database, wherein each stored identification number is associated with a stored vehicle type, and
selecting the stored vehicle type corresponding to the identification number as the vehicle type.

5. The system according to claim 1, wherein validating the risk comprises:
determining an association between the vehicle type and the at least one activity.

6. A computer-based method for validating a level of risk associated with an insurance policy comprising:
receiving, by a computer comprising at least one processor, a request for the insurance policy from a customer, wherein the request identifies at least one activity to be covered by the insurance policy, and wherein the request includes information regarding at least one vehicle to be operated in association with the at least one activity;
classifying, by the computer, the level of risk;
obtaining, by the computer, a vehicle identification number for each of the at least one vehicles;
determining, by the computer, a vehicle type for each of the at least one vehicles based on the vehicle identification number; and
validating the level of risk based on at least one of the vehicle types.

7. The method according to claim 6, wherein each of the vehicle identification numbers is obtained from at least one of the customer, a third party, and a database.

8. The method according to claim 7, wherein determining the vehicle type comprises:
comparing a portion of the vehicle identification number to stored vehicle identifiers, wherein each stored vehicle identifier corresponds to a stored vehicle type; and
designating the stored vehicle type corresponding to a stored vehicle identifier that matches the portion of the vehicle identification number as the vehicle type.

9. The method according to claim 6, further comprising:
verifying a validity of at least one of the vehicle identification numbers.

10. The method according to claim 9, wherein each of the vehicle identification numbers includes a check digit calculated according to a formula; and
wherein verifying the validity comprises calculating a checksum according to the formula, and comparing the checksum to the check digit.

11. The method according to claim 6, further comprising:
calculating a premium for the insurance policy.

12. The method according to claim 6, further comprising:
if the risk is validated based on the vehicle type, issuing the insurance policy; and
if the risk is not validated based on the vehicle type, sending the insurance policy to an underwriter.

13. The method according to claim 6, further comprising:
determining, based on at least one of the vehicle identification numbers, a model year of the at least one vehicle for which the at least one of the vehicle identification numbers has been obtained.

14. The method according to claim 6, further comprising:
determining, for the at least one vehicle, whether a manufacturer of the at least one vehicle assembled 500 or more vehicles during the year in which the at least one vehicle was assembled.

15. The method according to claim 6, further comprising:
rating the policy based on the level of risk.

16. The method according to claim 6, further comprising:
analyzing the policy according to at least one business rule.

17. The method according to claim 16, wherein the at least one business rule determines a valuation category of the at least one vehicle.

18. The method according to claim 6, further comprising sending the policy to the customer.

19. A computer-implemented method for validating a level of risk associated with an insurance policy covering at least one activity comprising:
receiving, by a computer comprising at least one processor, a request for the policy;
classifying, by the computer, the level of risk;
receiving, by the computer, at least one intrinsic identifier associated with the at least one activity over the network; and
validating, by the computer, the level of risk based on the at least one intrinsic identifier.

20. The method according to claim 19, wherein the request comprises information regarding the at least one activity provided by a customer.

21. The method according to claim 19, wherein the request includes information regarding at least one vehicle to be operated during the at least one activity, and
wherein the at least one intrinsic identifier comprises an identification number of the at least one vehicle.

22. The method according to claim 21, further comprising:
verifying the validity of the identification number.

23. The method according to claim 22, wherein the identification number includes a check digit calculated according to a formula, and
wherein verifying the validity comprises calculating a checksum according to the formula, and comparing the checksum to the check digit.

24. The method according to claim 21, further comprising:
determining a vehicle type for the at least one vehicle based on the identification number.

25. The method according to claim 24, wherein validating the level of risk comprises determining an association between the vehicle type and the at least one activity.

26. The method according to claim 25, further comprising:
if the risk is validated based on the vehicle type, issuing the insurance policy; and
if the risk is not validated based on the vehicle type, sending the insurance policy to an underwriter.

27. The method according to claim 19, further comprising:
calculating a premium for the insurance policy based on the level of risk.

28. The method according to claim 19, further comprising:
issuing the policy.
